(19) United States
(12) Patent Application Publication
(10) Pub. No.: US 2024/0393534 A1
(43) Pub. Date: Nov. 28, 2024

(54) GRATING COUPLER

(71) Applicant: Mitsubishi Electric Corporation, Tokyo (JP)

(72) Inventors: Yojiro WATANABE, Tokyo (JP); Satoshi NISHIKAWA, Tokyo (JP)

(73) Assignee: Mitsubishi Electric Corporation, Tokyo (JP)

(21) Appl. No.: 18/693,342

(22) PCT Filed: Jan. 11, 2022
(86) PCT No.: PCT/JP2022/000563

§ 371 Date: Mar. 19, 2024

(51) Int. Cl. G02B 6/124; G02B 6/12; G02B 6/42

(52) U.S. Cl. CPC G02B 6/124; G02B 6/4212; G02B 2006/12147

(57) ABSTRACT

A grating coupler according to the present disclosure includes a substrate that has a waveguide layer in which a diffraction grating is provided and a clad layer provided on the waveguide layer, wherein an emission end surface, of the substrate, from which diffracted light from the diffraction grating is to be emitted is inclined relatively to a direction perpendicular to an upper surface of the substrate.

### FIELD

The present disclosure relates to a grating coupler.

### BACKGROUND

PTL 1 discloses an optical semiconductor device in which light from a diffraction grating formed in a semiconductor substrate is emitted from an upper surface of the semiconductor substrate. In PTL 1, an optical fiber is caused to adjoin the upper surface of the semiconductor substrate from an upper side of the semiconductor substrate, and light from the diffraction grating is coupled to an end surface of the optical fiber.

### CITATION LIST

### Patent Literature

[PTL 1] U.S. Pat. No. 8,280,207 B2

### SUMMARY

### Technical Problem

In a structure as in PTL 1, a beam size of light emitted from a diffraction grating is adapted to a mode size of an optical fiber, and high efficiency coupling without using a lens thereby becomes possible. However, in a case where a metal wire or another chip is arranged on an optical circuit, the optical fiber provided on an upper surface of a semiconductor substrate might become a spatial obstacle, and mounting might thereby be restricted.

An object of the present disclosure is to obtain a grating coupler that can improve flexibility of mounting of a component.

### Solution to Problem

A grating coupler according to the present disclosure includes a substrate that has a waveguide layer in which a diffraction grating is provided and a clad layer provided on the waveguide layer, wherein an emission end surface, of the substrate, from which diffracted light from the diffraction grating is to be emitted is inclined relatively to a direction perpendicular to an upper surface of the substrate.

### Advantageous Effects of Invention

In a grating coupler according to the present disclosure, diffracted light is emitted from an inclined emission end surface. Thus, a member to which the diffracted light is to be coupled does not have to be arranged on an upper surface of a substrate, and flexibility of mounting of a component on the substrate can be improved.

### BRIEF DESCRIPTION OF DRAWINGS

FIG. 1 is a perspective view of a grating coupler according to a first embodiment.

FIG. 2 is a plan view of the grating coupler according to the first embodiment.

FIG. 3 is a cross-sectional view that can be obtained by sectioning FIG. 2 along an A-B straight line.

FIG. 4 is a diagram for explaining angles θ, θₐ, θ_{b}, θ_{c}, and θ_{d}.

FIG. 5 is a diagram for explaining the method of manufacturing the grating coupler according to the first embodiment.

FIG. 6 is a diagram for explaining the method of manufacturing the grating coupler according to the first embodiment.

FIG. 7 is a diagram for explaining the method of manufacturing the grating coupler according to the first embodiment.

FIG. 8 is a diagram illustrating a diffraction grating according to a first modification of the first embodiment.

FIG. 9 is a diagram illustrating a diffraction grating according to a second modification of the first embodiment.

FIG. 10 illustrates a plan view and a cross-sectional view of a grating coupler according to a second embodiment.

FIG. 11 is a diagram illustrating the coupling efficiency of the grating coupler according to the second embodiment.

FIG. 12 is a perspective view of a grating coupler according to a third embodiment.

FIG. 13 is a diagram illustrating a state where the optical fiber is mounted on the grating coupler according to the third embodiment.

FIG. 14 is a diagram for explaining the method of manufacturing the grating coupler according to the third embodiment.

FIG. 15 is a diagram for explaining the method of manufacturing the grating coupler according to the third embodiment.

FIG. 16 is a diagram for explaining the method of manufacturing the grating coupler according to the third embodiment.

FIG. 17 is a diagram for explaining the method of manufacturing the grating coupler according to the third embodiment.

FIG. 18 is a diagram for explaining the method of manufacturing the grating coupler according to the third embodiment.

FIG. 19 is a cross-sectional view of a grating coupler according to a fourth embodiment in a light propagation direction.

FIG. 20 is a cross-sectional view that can be obtained by sectioning FIG. 19 along an I-J straight line.

### DESCRIPTION OF EMBODIMENTS

Grating couplers according to each embodiment will be described with reference to the drawings. Identical or corresponding constitutional elements are given the same reference numerals, and the repeated description of such constitutional elements may be omitted.

### First Embodiment

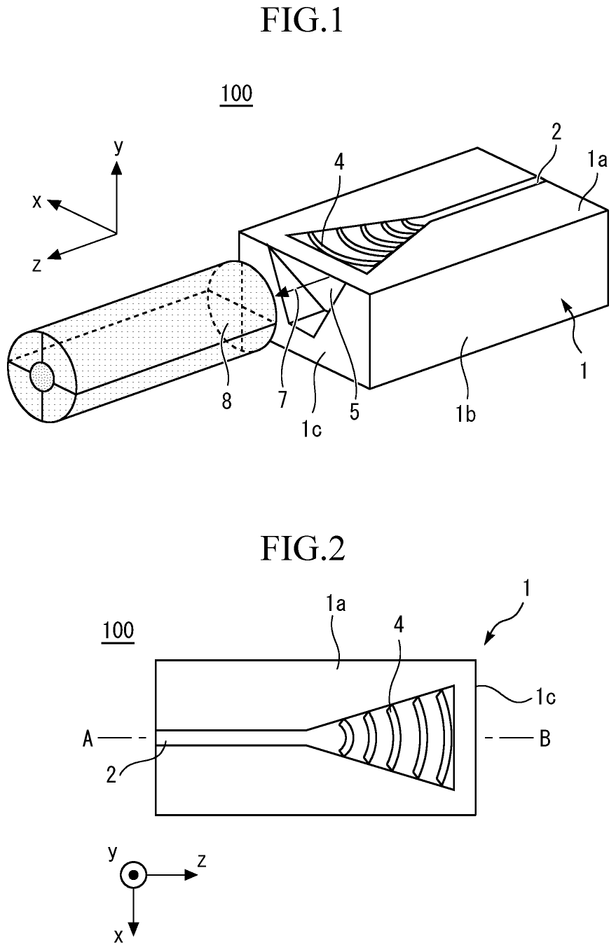

FIG. 1 is a perspective view of a grating coupler 100 according to a first embodiment. The grating coupler 100 is used for an optical chip, which is referred to as photonic integrated circuits (PIC), for example. The grating coupler 100 includes a substrate 1. The substrate 1 is an InP substrate, for example. In the substrate 1, an upper surface 1a is a (100) plane, a side surface 1b is a (0-1-1) plane, and an end surface 1c in a light emission direction is (0-11). A term (hkl) denotes a Miller index of a crystal plane while h, k, and l are provided as integers.

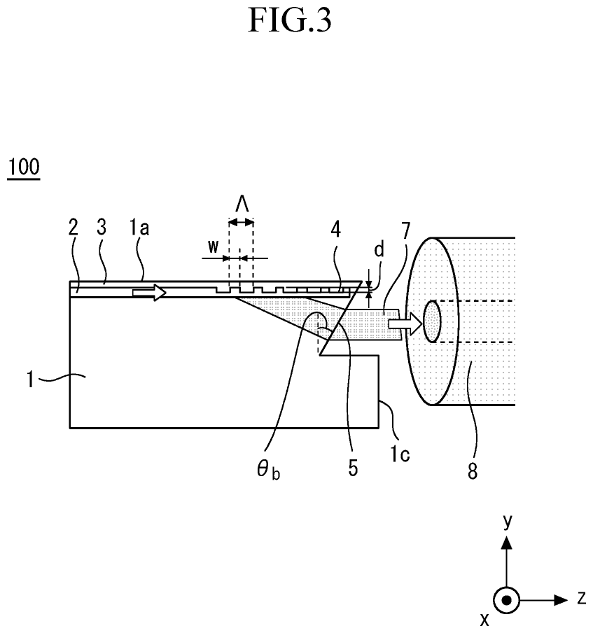

FIG. 2 is a plan view of the grating coupler 100 according to the first embodiment. FIG. 3 is a cross-sectional view that can be obtained by sectioning FIG. 2 along an A-B straight line. The substrate 1 has a waveguide layer 2 in which a diffraction grating 4 is provided and a clad layer 3 provided on the waveguide layer 2. The waveguide layer 2 is formed of InGaAsP, for example. The clad layer 3 is formed of InP, for example. The diffraction grating 4 is a long-period diffraction grating with a pitch A of 4 to 15 μm, for example.

As illustrated in FIG. 2, a width of the diffraction grating 4 becomes wider as approaching the end surface 1c. The diffraction grating 4 is formed with curves such as elliptic arcs, and light-collecting characteristics of diffracted light in an x-axis direction can thereby be adjusted. Consequently, a size of an emitted beam and a depth of focus can be adjusted to magnitudes suitable for a purpose of use. Further, a width of the waveguide layer 2 in which the diffraction grating 4 is provided preferably becomes wider toward the end surface 1c. In a portion at an equal width in the waveguide layer 2, light becomes a plane wave. When the width of the waveguide layer 2 becomes wider, a wavefront of diffracted light 7 has curvature. The diffraction grating 4 is formed in accordance with the curvature, and the light can thereby be diffracted with a high beam quality.

An emission end surface 5 of the substrate 1 is a surface from which the diffracted light 7 from the diffraction grating 4 is emitted. The emission end surface 5 is inclined at an angle of θ_{b} relatively to a direction perpendicular to the upper surface of the substrate 1. The direction perpendicular to the upper surface of the substrate 1 is a y-axis direction. Toward a lower side, the emission end surface 5 further enters an inside of the substrate 1.

The pitch A of the diffraction grating 4 is a distance between rising edges of the diffraction grating 4. Further, w denotes a line width of a main tooth of the diffraction grating 4, d denotes a thickness of the diffraction grating 4. For example, at an operating wavelength of 1,530 to 1,570 nm, a typical pitch A is 4 to 15 μm. Further, a typical line width w corresponds to 10% to 60% of the pitch A in accordance with whether or not a sub diffraction grating is included or how the diffraction grating 4 is designed. A typical thickness d is 0.2 to 1 μm.

The diffraction grating 4 diffracts the light propagated through the substrate 1 at a shallow angle. The diffracted light 7 is propagated in a direction inclined downward relatively to the diffraction grating 4, is refracted at the emission end surface 5 in a direction along the diffraction grating 4, and is emitted from the emission end surface 5. An emission direction of the diffracted light 7 is a z-axis direction. The emitted diffracted light 7 is focused on, for example, an end surface of an optical fiber 8, and is guided in the optical fiber 8.

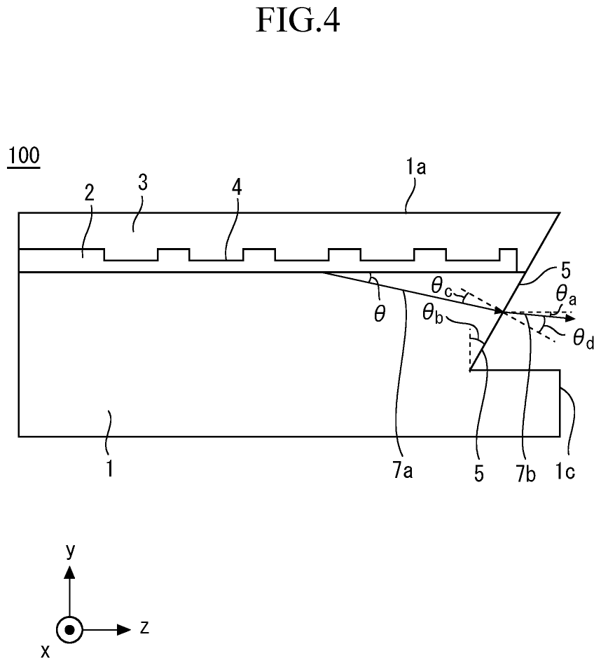

FIG. 4 is a diagram for explaining angles θ, θₐ, θ_{b}, θ_{c}, and θ_{d}. In the following, the diffracted light 7 propagated in the substrate 1 may be denoted as diffracted light 7a, and the diffracted light 7 emitted from the emission end surface 5 may be denoted as diffracted light 7b. The angle θ is an angle between the waveguide layer 2 and the diffracted light 7a. The angle θa is an angle between the z axis and the diffracted light 7b. The angle θ_{b} is an angle formed by the y axis and the emission end surface 5. The angle θ, is an incident angle of the diffracted light 7a on the emission end surface 5. The angle θ_{d} is an emission angle of the diffracted light 7b from the emission end surface 5.

A relationship among a diffraction angle θ, a refractive index, and the pitch A can be expressed as an expression (1).

$$[ Math . 1 ]$$

$${k}_{0} ( {n}_{eff} - {n}_{s} cos θ ) = m \frac{2 π}{Λ} \qquad ( 1 )$$

Here, k₀=2π/λ represents a wave vector in a vacuum. A term λ represents a wavelength in a vacuum. A term n_{eff} represents an effective refractive index of the waveguide layer 2. A term ns represents a refractive index of the substrate 1. A term m represents order of diffraction. Usually, first-order diffracted light provides maximum coupling efficiency. Thus, m=1 is used in view of practical use.

The angles θ_{c}, θ_{d} and θₐ, can be expressed by the following expressions.

$$[ Math . 2 ]$$

$${θ}_{c} = {θ}_{b} - θ \qquad ( 2 )$$

$$[ Math . 3 ]$$

$${n}_{s} sin {θ}_{c} = {n}_{a} sin {θ}_{d} \qquad ( 3 )$$

$$[ Math . 4 ]$$

$${θ}_{a} = {θ}_{b} - {θ}_{d} \qquad ( 4 )$$

Here, a term nₐ represents a refractive index of a medium through which the diffracted light 7b is propagated. In a case where the medium is air, nₐ=1. For example, as for typical InP at a wavelength of 1,550 nm, nₐ=3.169, n_{eff}=3.244, Λ=4.3 μm, and θ_{b}=35 degrees. In this case, θ=25 degrees and θₐ=0 degree are obtained. In other words, the diffracted light 7b is emitted in the z-axis direction.

As a comparative example of the present embodiment, in a case where the diffracted light is output in the y-axis direction, the optical fiber has to be installed above a chip. In this configuration, in a case where a metal wire, another chip, or the like is arranged on an optical circuit, the optical fiber possibly becomes a spatial obstacle, and mounting is thereby possibly restricted. On the other hand, in the present embodiment, the diffracted light 7 is emitted from the inclined emission end surface 5. Thus, a member such as the optical fiber 8, to which the diffracted light 7 is coupled, does not have to be arranged on the upper surface 1a of the substrate 1. Consequently, restriction of mounting of a component on the substrate 1 can be reduced, and flexibility of mounting can thereby be improved.

In the present embodiment, highly efficiently and without using a lens, the diffracted light 7 can be coupled to a waveguide of the optical fiber 8 that is arranged on the end surface 1c side of a chip. In particular, because the diffracted light 7 is output in a horizontal direction, the optical fiber 8 can be installed in the z-axis direction. Thus, position adjustment for the optical fiber 8 can easily be performed.

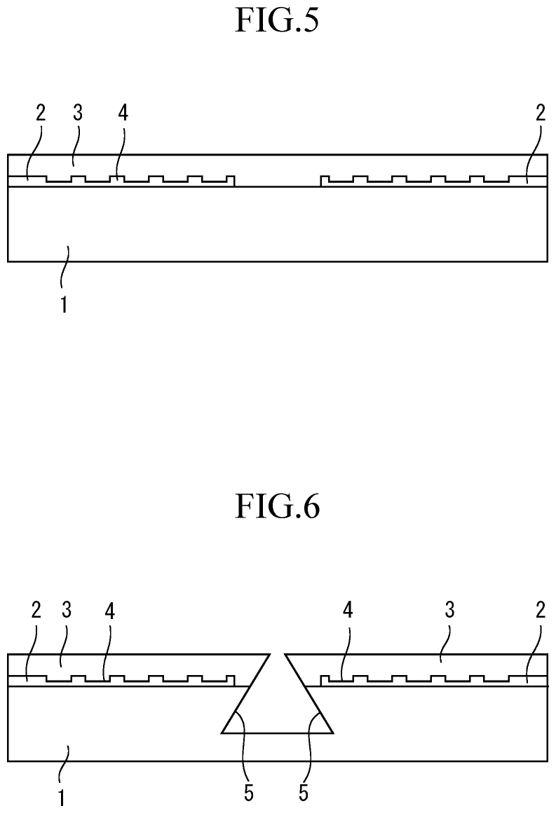

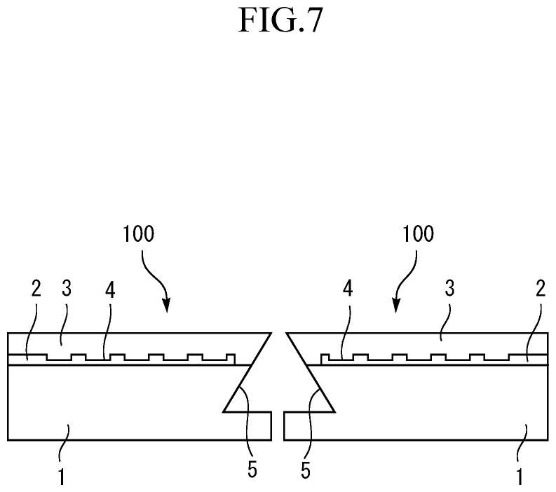

Next, a method of manufacturing the grating coupler 100 will be described. FIGS. 5 to 7 are diagrams for explaining the method of manufacturing the grating coupler 100 according to the first embodiment. First, as illustrated in FIG. 5, structures including the waveguide layers 2, the clad layers 3, and the diffraction gratings 4 are formed on the substrate 1. Next, as illustrated in FIG. 6, a recess portion is formed in the substrate 1 by anisotropic etching. By an anisotropic etching step, side surfaces of the substrate 1 that form the recess portion can be formed as inclined surfaces at prescribed angles. Those inclined surfaces become the emission end surfaces 5. Subsequently, as illustrated in FIG. 7, the substrate 1 is separated by cleaving in a central portion of the recess portion.

Next, a description will be made about the fact that the diffraction grating 4 has a long period. The period, in other words, the pitch Λ of the diffraction grating 4 depends on the diffraction angle θ of the diffracted light 7. In a case where the diffracted light 7a is diffracted at a shallow angle relative to the horizontal direction as in the present embodiment, the diffraction grating 4 has a long period. On the other hand, in a case where diffracted light is diffracted at an angle close to the y-axis direction or a DBR (distributed Bragg reflector) mirror is formed in the waveguide layer 2, a diffraction grating has a short period.

Because the diffracted light 7a is diffracted at the shallow angle θ in the present embodiment, a long-period diffraction grating can be employed as the diffraction grating 4. Thus, exposure precision of the diffraction grating 4 can be reduced compared to a short-period diffraction grating. Consequently, the grating coupler 100 can easily be fabricated. In particular, in a compound semiconductor manufacturing process, fine processing precision is in general low compared to a Si manufacturing process. Thus, there are cases where highly precise formation of the short-period diffraction grating is difficult. Consequently, in the compound semiconductor manufacturing process, the long-period diffraction grating of the present embodiment is particularly effective.

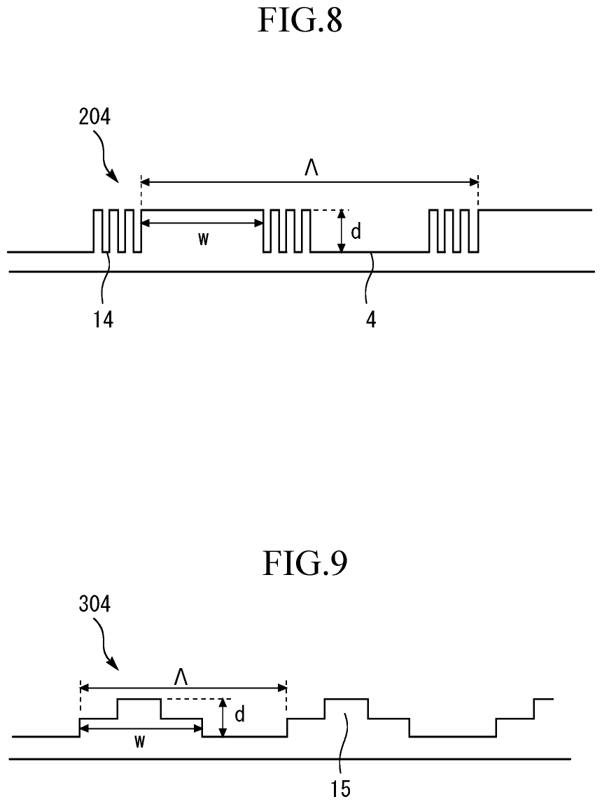

FIG. 8 is a diagram illustrating a diffraction grating 204 according to a first modification of the first embodiment. The diffraction grating 204 includes a sub diffraction grating 14 in addition to the diffraction grating 4 with the pitch Λ. A period of the sub diffraction grating 14 is smaller than that of the diffraction grating 4. Diffraction in unnecessary directions can be inhibited by design of the sub diffraction grating 14. Consequently, high coupling efficiency can be obtained.

FIG. 9 is a diagram illustrating a diffraction grating 304 according to a second modification of the first embodiment. The diffraction grating 304 is of a multi-step type. In the diffraction grating 304, a stepped structure is formed in a main tooth with a line width w. In the diffraction grating 304, diffraction in unnecessary directions can also be inhibited by design of the stepped structure, and high coupling efficiency can be obtained.

The present embodiment can be applied to any system that couples output light of an optical chip to a waveguide such as an optical fiber. The waveguide layer 2 may include a semiconductor laser oscillator, a semiconductor optical amplifier, an electro-absorption type optical modulator, and so forth. Further, a member to which the diffracted light 7 is coupled is not limited to the optical fiber 8. Further, an emission direction of the diffracted light 7b may be shifted from the z-axis direction.

These modifications can be applied, as appropriate, to grating couplers according to the following embodiments. Note that the grating couplers according to the following embodiments are similar to that of the first embodiment in many respects, and thus differences between the grating couplers according to the following embodiments and that of the first embodiment will be mainly described below.

### Second Embodiment

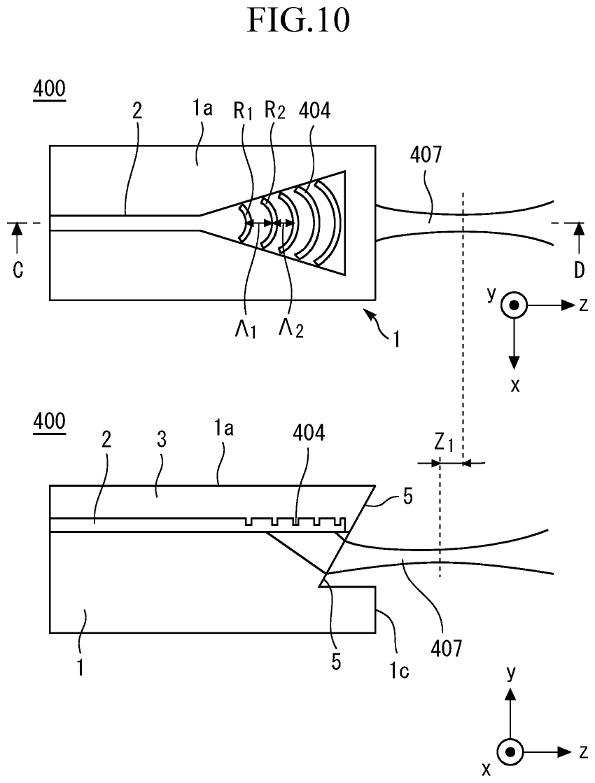

FIG. 10 illustrates a plan view and a cross-sectional view of a grating coupler 400 according to a second embodiment. The cross-sectional view in FIG. 10 can be obtained by sectioning the plan view along a C-D straight line. In the grating coupler 400 of the present embodiment, a structure of a diffraction grating 404 is different from that of the grating coupler 100. Other structures are similar to structures of the first embodiment. In the diffraction grating 404 of the present embodiment, the pitch A changes in a propagation direction of diffracted light 407 in a planar view. Further, in the diffraction grating 404, a radius of curvature R changes in the propagation direction of the diffracted light 407 in the planar view. Here, the propagation direction of the diffracted light 407 in the planar view is the z-axis direction.

In the grating coupler 400, pitches Λ₁, Λ₂, Λ₃, . . . of the diffraction grating 404 are changed, and light collection of the diffracted light 407 in the y-axis direction can thereby be adjusted. Further, radii of curvature R₁, R₂, R₃, . . . of the diffraction grating 404 are changed, and light collection of the diffracted light 407 in the x-axis direction can thereby be adjusted. Consequently, the pitches A and the radii of curvature R of the diffraction grating 404 are adjusted, and the diffracted light 407 can thereby be coupled so as to correspond to a mode field of the optical fiber 8.

In the present embodiment, light collection positions for the diffracted light 407 are changed by Z1 between the x-axis direction and the y-axis direction. In other words, a light collection position in a direction perpendicular to the propagation direction of the diffracted light 407 in the planar view is shifted from a light collection position in a direction perpendicular to the upper surface of the substrate 1. This Z1 is also referred to as astigmatic difference.

In the following, it is assumed that an optical axis is parallel with the z axis. Further, it is assumed that the diffracted light 407 is a Gaussian beam. When the light collection position in the x-axis direction is set to z=0, characteristics in the x-axis direction are expressed as follows.

$$[ Math . 5 ]$$

$${z}_{0 x} = \frac{π {w}_{0 x}^{2}}{λ} \qquad ( 5 )$$

$$[ Math . 6 ]$$

$${w}_{x} ( z ) = {w}_{0 x} \sqrt{1 + {( \frac{z}{{z}_{0 x}} )}^{2}} \qquad ( 6 )$$

$$[ Math . 7 ]$$

$${R}_{x} ( z ) = z [ 1 + {( \frac{{z}_{0 x}}{z} )}^{2} ] \qquad ( 7 )$$

Here, a term w₀ₓ represents a spot size in the light collection position. A term λ represents a wavelength. A term wₓ(z) represents the spot size in an arbitrary position z. A term Rₓ(z) represents a wavefront.

When the light collection position in the y-axis direction is set to z=z₁, characteristics in the y-axis direction are expressed as follows.

$$[ Math . 8 ]$$

$${z}_{0 y} = \frac{π {w}_{0 y}^{2}}{λ} \qquad ( 8 )$$

$$[ Math . 9 ]$$

$${w}_{y} ( z ) = {w}_{0 y} \sqrt{1 + {( \frac{z - {z}_{1}}{{z}_{0 y}} )}^{2}} \qquad ( 9 )$$

$$[ Math . 10 ]$$

$${R}_{y} ( z ) = ( z - {z}_{1} ) [ 1 + {( \frac{{z}_{0 y}}{z - {z}_{1}} )}^{2} ] \qquad ( 10 )$$

Here, a term Woy represents the spot size in the light collection position. A term w_{y}(z) represents the spot size in the arbitrary position z. A term R_{y}(z) represents a wavefront.

It is assumed that an end surface of a waveguide such as an optical fiber having respective mode field diameters 2W_{wx} and 2W_{wy} in the x-axis direction and the y-axis direction is installed in the arbitrary position z. In this case, coupling efficiency η(z) of the diffracted light 407 to the waveguide is expressed as follows.

$$[ Math . 11 ]$$

$$η ( z ) = {η}_{x} ( z ) {η}_{y} ( z ) \qquad ( 11 )$$

$$[ Math . 12 ]$$

$${η}_{x} ( z ) = \frac{2}{\sqrt{{[ \frac{{w}_{w x}}{{w}_{x} ( z )} + \frac{{w}_{x} ( z )}{{w}_{w x}} ]}^{2} + {[ \frac{{k}_{0}}{2} {w}_{x} ( z ) {w}_{w x} \frac{1}{{R}_{x} ( z )} ]}^{2}}} \qquad ( 12 )$$

$$[ Math . 13 ]$$

$${η}_{y} ( z ) = \frac{2}{\sqrt{{[ \frac{{w}_{w y}}{{w}_{y} ( z )} + \frac{{w}_{y} ( z )}{{w}_{w y}} ]}^{2} + {[ \frac{{k}_{0}}{2} {w}_{y} ( z ) {w}_{w y} \frac{1}{{R}_{y} ( z )} ]}^{2}}} \qquad ( 13 )$$

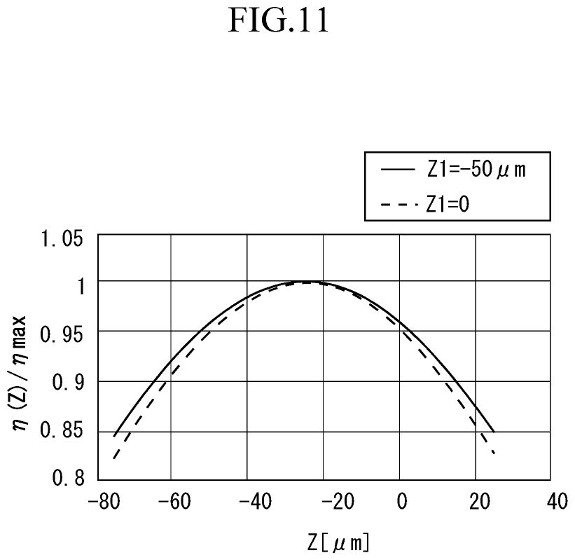

FIG. 11 is a diagram illustrating the coupling efficiency of the grating coupler 400 according to the second embodiment. The coupling efficiency illustrated in FIG. 11 is standardized coupling efficiency η(z)/ηMax in which a maximum value of η(z) is set as ηMax. For example, while it is assumed that the waveguide to which the diffracted light 407 is coupled is a typical single mode fiber, it is assumed that λ=1,550 nm, W₀ₓ=W_{0y}=5.2 μm, z₁=−50 μm, and W_{wx}=W_{wy}=5.2 μm. In this case, η(z)/ηMax is provided like a solid line in FIG. 8. A dotted line indicates a case where z₁=0, that is, the light collection positions for the diffracted light 407 are the same between the x-axis direction and the y-axis direction.

As illustrated in FIG. 11, compared to a case where the light collection positions for the diffracted light 407 are the same between the x-axis direction and the y-axis direction, in a case where a difference is present, a change in the coupling efficiency is small with respect to an axial shift along the z-axis direction. Consequently, in the present embodiment, a tolerance, in an optical axis direction, of the coupling efficiency of the diffracted light 407 to the optical fiber or the like can be enhanced.

In the present embodiment, the light collection position in the y-axis direction is adjusted by adjusting the pitches A of the diffraction grating 404, and the light collection position in the x-axis direction is adjusted by adjusting the radii of curvature R. Specifically, it is desirable to make the pitches A narrower as approaching the emission end surface 5. This means that the diffraction angle θ is made larger as approaching the emission end surface 5. Here, the angle Od is set such that θ°<θ_{d} <90°. Further, it is desirable to make the radii of curvature R larger as approaching the emission end surface 5.

### Third Embodiment

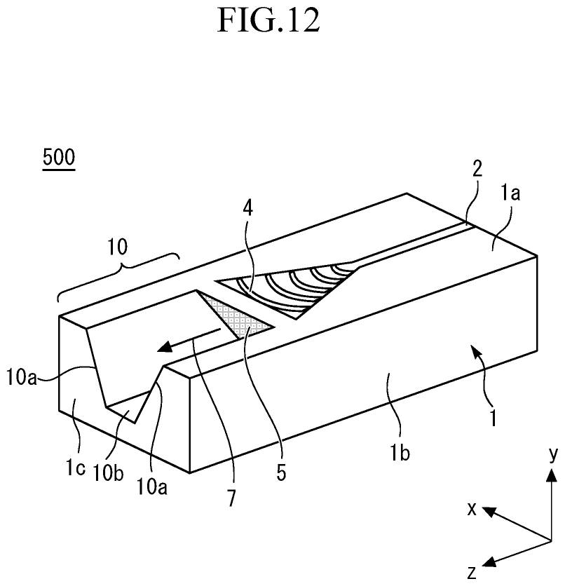

FIG. 12 is a perspective view of a grating coupler 500 according to a third embodiment. In the substrate 1 of the present embodiment, a groove 10 is formed from the end surface 1c of the substrate 1 in the propagation direction of the diffracted light 7 such that the emission end surface 5 becomes a bottom portion when seen in the z-axis direction. Other configurations are similar to configurations of the first embodiment.

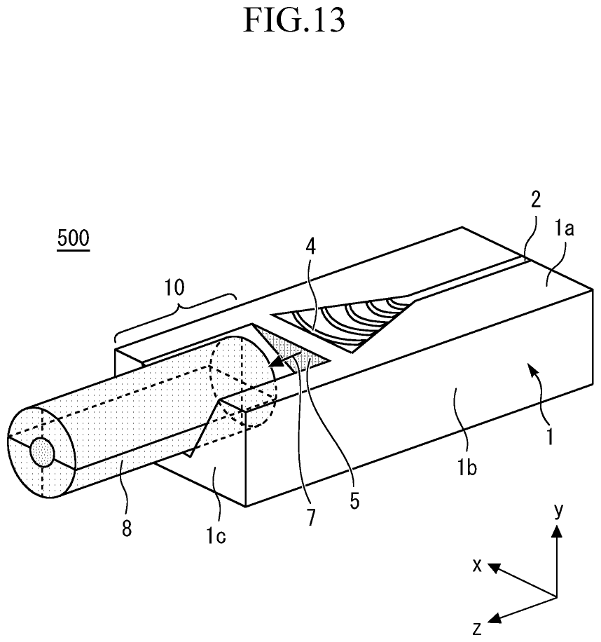

FIG. 13 is a diagram illustrating a state where the optical fiber 8 is mounted on the grating coupler 500 according to the third embodiment. The optical fiber 8 is arranged in the groove 10. The optical fiber 8 is installed so as to contact with side surfaces 10a or a bottom surface 10b of the substrate 1, which form the groove 10, or with both of those, for example. The groove 10 has a V shape or a U shape, for example, in a cross section parallel with the end surface 1c. Further, as illustrated in FIG. 12, the groove 10 may have a trapezoidal shape or the like in which a lower base is short compared to an upper base when seen from the end surface 1c side. In the present embodiment, because the optical fiber 8 can be installed in the groove 10, mounting of the optical fiber 8 can easily be performed.

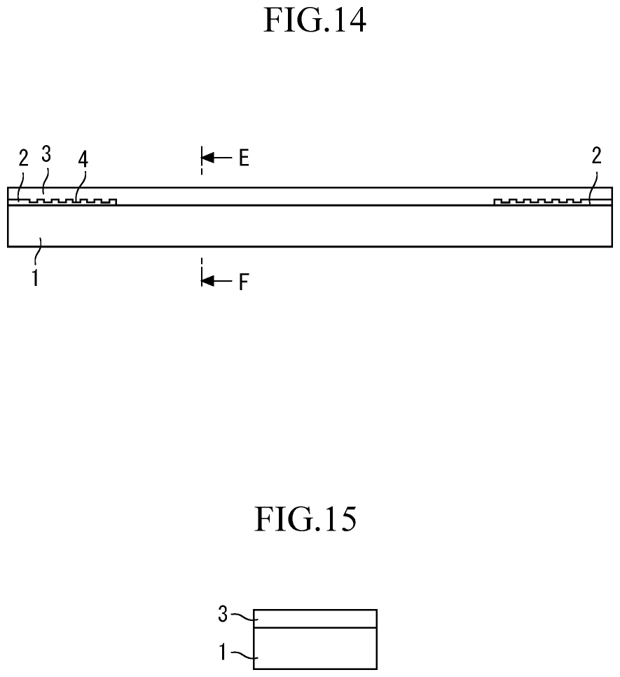

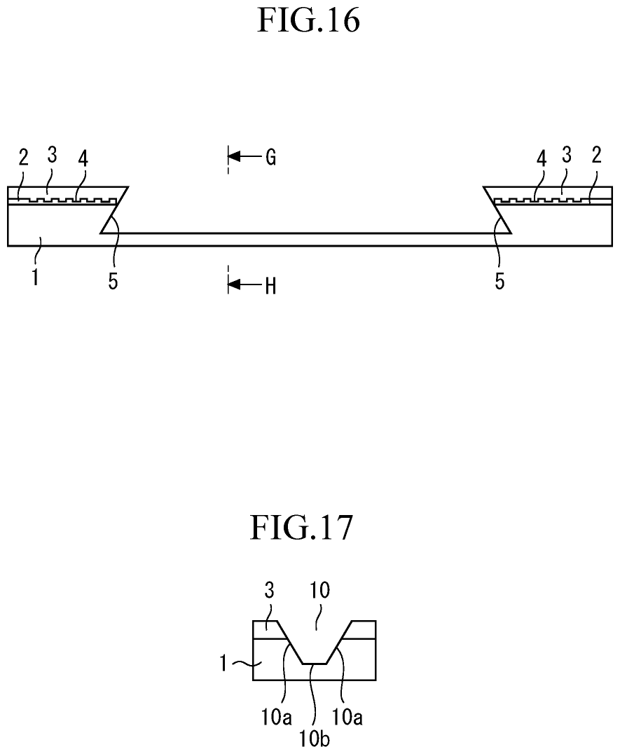

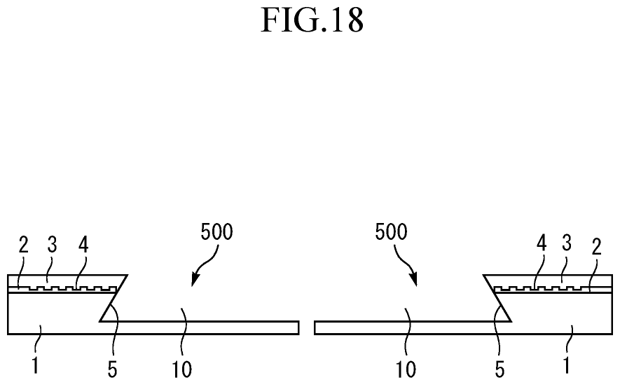

Next, a method of manufacturing the grating coupler 500 will be described. FIGS. 14 to 18 are diagrams for explaining the method of manufacturing the grating coupler 500 according to the third embodiment. First, as illustrated in FIG. 14, the waveguide layers 2, the clad layers 3, and the diffraction gratings 4 are formed on the substrate 1. FIG. 15 is a cross-sectional view that can be obtained by sectioning FIG. 14 along an E-F straight line. Next, as illustrated in FIG. 16, the emission end surfaces 5 are formed by anisotropic etching. FIG. 17 is a cross-sectional view that can be obtained by sectioning FIG. 16 along a G-H straight line. By the anisotropic etching, the side surfaces 10a and the bottom surface 10b of the groove 10 are simultaneously formed. Next, as illustrated in FIG. 18, the substrate 1 is separated by cleaving in a central portion of the emission end surfaces 5 on both sides.

### Fourth Embodiment

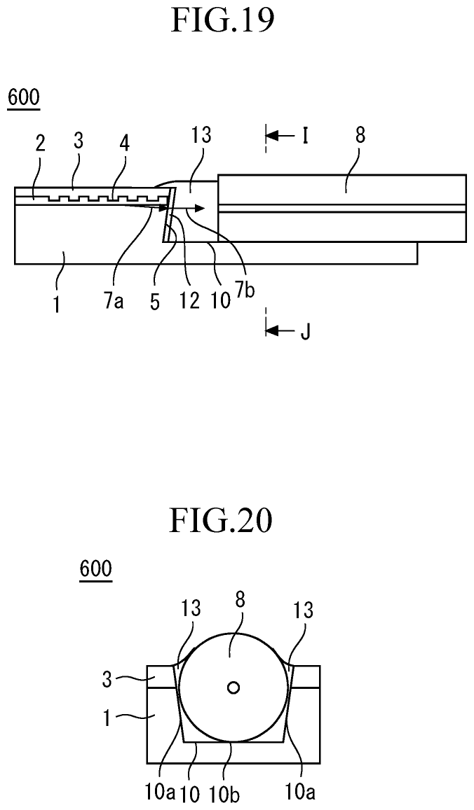

FIG. 19 is a cross-sectional view of a grating coupler 600 according to a fourth embodiment in a light propagation direction. FIG. 20 is a cross-sectional view that can be obtained by sectioning FIG. 19 along an I-J straight line. In the present embodiment, an antireflection film 12 is provided on the emission end surface 5. A portion between the antireflection film 12 and the optical fiber 8 is filled with a matching material 13 that corresponds to a refractive index of the optical fiber 8. Other configurations are similar to configurations of the third embodiment.

The matching material 13 may also serve as an adhesive for fixing the optical fiber 8. Further, the antireflection film 12 is designed to inhibit reflection by the matching material 13. The matching material 13 may be GA700H produced by NTT Advanced Technology Corporation, for example.

The grating coupler 600 of the present embodiment can inhibit reflection at the emission end surface 5 and the end surface of the optical fiber 8. Thus, the coupling efficiency can be improved.

Note that the technical features described in the above embodiments may be combined as appropriate.

### REFERENCE SIGNS LIST

1 substrate, 1a upper surface, 1b side surface, 1c end surface, 2 waveguide layer, 3 clad layer, 4 diffraction grating, 5 emission end surface, 7, 7a, 7b diffracted light, 8 optical fiber, 10 groove, 10a side surface, 10b bottom surface, 12 antireflection film, 13 matching material, 14 sub diffraction grating, 100 grating coupler, 204, 304 diffraction grating, 400 grating coupler, 404 diffraction grating, 407 diffracted light, 500, 600 grating coupler

1. A grating coupler comprising:
a substrate that has a waveguide layer in which a diffraction grating is provided and a clad layer provided on the waveguide layer,
wherein an emission end surface, of the substrate, from which diffracted light from the diffraction grating is to be emitted is inclined relatively to a direction perpendicular to an upper surface of the substrate,
the diffracted light is propagated inside the substrate to the emission end surface, and
the diffracted light is propagated in a direction inclined downward relatively to the diffraction grating, is refracted at the emission end surface, and is emitted from the emission end surface in a direction along the diffraction grating.

2. (canceled)

3. The grating coupler according to claim 1,
wherein a light collection position in a direction perpendicular to a propagation direction of the diffracted light in a planar view is shifted from a light collection position in the direction perpendicular to the upper surface of the substrate.

4. The grating coupler according to claim 3,
wherein a pitch of the diffraction grating changes in the propagation direction of the diffracted light in the planar view.

5. The grating coupler according to claim 3,
wherein a radius of curvature of the diffraction grating changes in the propagation direction of the diffracted light in the planar view.

6. The grating coupler according to claim 1,
wherein, in the substrate, a groove is formed from an end surface of the substrate in a propagation direction of the diffracted light such that the emission end surface becomes a bottom portion, and
a member to which the diffracted light is to be coupled is arranged in the groove.

7. The grating coupler according to claim 1,
wherein an antireflection film is provided on the emission end surface, and
a portion between the antireflection film and a member to which the diffracted light is to be coupled is filled with a matching material that corresponds to a refractive index of the member.
